(19) United States
(12) Patent Application Publication
(10) Pub. No.: US 2025/0370396 A1
(43) Pub. Date: Dec. 4, 2025

(54) IMAGE FORMING APPARATUS AND ELECTRIC UNIT

(71) Applicant: CANON KABUSHIKI KAISHA, Tokyo (JP)

(72) Inventor: KOTARO TORIKATA, Chiba (JP)

(21) Appl. No.: 19/220,357

(22) Filed: May 28, 2025

(30) Foreign Application Priority Data
May 29, 2024 (JP) 2024-087382

(51) Int. Cl. G03G 15/00

(52) U.S. Cl. CPC G03G 15/80

(57) ABSTRACT

An image forming apparatus provided with an electric unit includes an electric substrate, first and second sheet metals. The electric substrate includes a mounting surface on which an electric component is mounted. The first sheet metal includes a first plate portion. The second sheet metal includes a second plate portion disposed on the same side as the first plate portion with reference to the mounting surface of the electric substrate. A first opening penetrating the first plate portion in a thickness direction of the first plate portion is formed in the first plate portion. As seen along the thickness direction of the first plate portion, the second plate portion covers at least a part of the first opening.

### BACKGROUND

### Field of the Technology

The present disclosure relates to an image forming apparatus and an electric unit for the image forming apparatus.

### DESCRIPTION OF THE RELATED ART

An electric substrate which an electric component mounted is installed in the image forming apparatus. A structure of image forming apparatus that a shielding case accommodates the electric substrate described above and shield it electrically is suggested in Japanese Laid-Open Patent Application No. 2013-191797.

### SUMMARY

In one aspect of an embodiment, an image forming apparatus provided with an electric unit, the electric unit comprising: an electric substrate including a mounting surface on which an electric component is mounted; a first sheet metal including a first plate portion; and a second sheet metal including a second plate portion disposed on the same side as the first plate portion with respect to the mounting surface of the electric substrate, wherein a first opening is formed in the first plate portion, the first opening penetrating the first plate portion in a thickness direction of the first plate portion, and wherein when viewed in the thickness direction of the first plate portion, the second plate portion covers at least a part of the first opening.

In another aspect of the present embodiment, an electric unit is mainly used in an image forming apparatus. An electric unit for an image forming apparatus, the electric unit comprising: an electric substrate including a mounting surface on which an electric component is mounted; a first sheet metal including a first plate portion; and a second sheet metal including a second plate portion disposed on the same side as the first plate portion with respect to the mounting surface of the electric substrate, wherein a first opening is formed in the first plate portion, the first opening penetrating the first plate portion in a thickness direction of the first plate portion, and wherein when viewd in the thickness direction of the first plate portion, the second plate portion covers at least a part of the first opening.

Further features of the present invention will become apparent from the following description of exemplary embodiments with reference to the attached drawings.

### BRIEF DESCRIPTION OF THE DRAWINGS

FIG. 1 is a perspective view showing an image forming apparatus as seen from its back side in the present embodiment.

FIG. 2 is a perspective view showing an electric unit in the present embodiment.

Part (a) and part (b) of FIG. 3 are disassembled perspective views showing a shielding case in the present embodiment. Part (a) shows the shielding case before the electric unit is mounted, and Part (b) shows the shielding case after the electric unit is mounted.

FIG. 4 is a disassembled perspective view showing the shielding case as seen from its back side in the present embodiment.

FIG. 5 is a perspective view showing the shielding case as seen from its back side in the present embodiment.

FIG. 6 is a disassembled perspective view showing the shielding case as seen from its front side in the present embodiment.

FIG. 7 is a perspective view showing the shielding case as seen from its front side in the present embodiment.

### DESCRIPTION OF THE EMBODIMENTS

In some embodiments of the present disclosure, an image forming apparatus and an electric unit which will be able to improve shielding performance for an electric substrate will be provided. When the shielding case is formed with metal member such as a sheet metal, an opening is possible to be formed in a making process. The inventor of the present disclosure noticed this problem that these openings may be a risk which reduces the shielding performance of the shielding case.

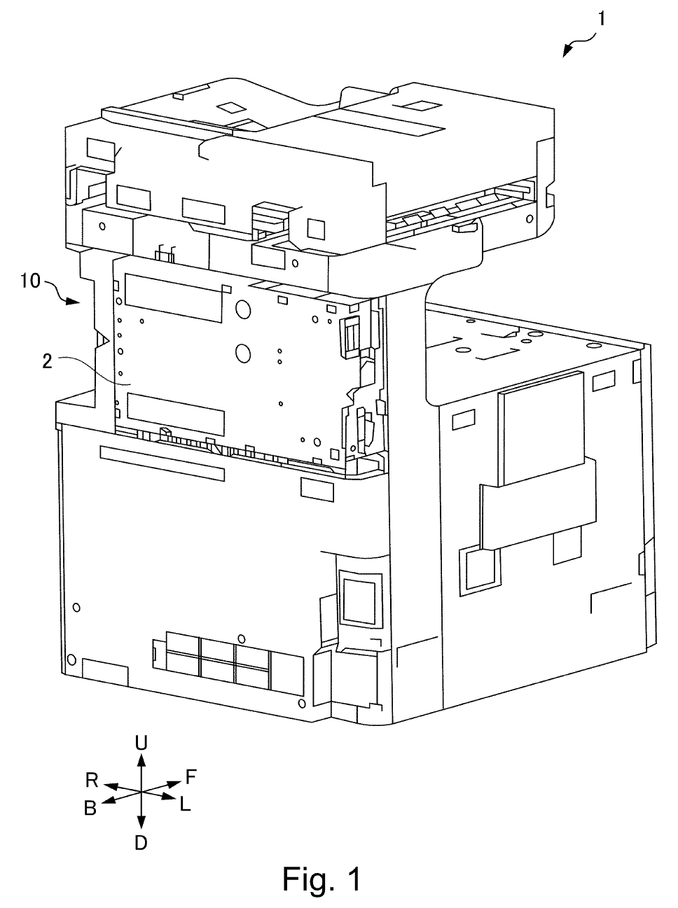

A present embodiment will be exemplary described with referring to the drawings FIG. 1 through FIG. 7. Note that: constituents described in the following embodiment is simply an example, and variable conditions such as structures, functions, sizes, materials, shapes, and relative positions of component parts of the apparatus that the present invention is applied are correctable and modifiable as far as not deviating the object of the present invention, and a scope of this invention is not limited to these disclosed embodiments in the following. First, a schematic structure of an image forming apparatus 1 in the present embodiment will be described with FIG. 1. In the present embodiment, a front side of an apparatus is the front side of the image forming apparatus 1 where a controlling portion is located and a user stands by to use and operate it. In Figures, directions are shown as follows: a front side is a front direction F, a back side is a back direction B, an upside is an up direction U, a downside is a down direction D, a right side seen from the front side is a right direction R and a left side is a left direction L.

FIG. 1 is a perspective view showing the image forming apparatus 1 seen from a back side (a back direction B) in the present embodiment. The image forming apparatus 1 includes: for example, an image forming portion wherein an image is formed on a sheet, a feeding portion wherein a sheet is fed from a sheet cassette through the image forming portion to a discharging tray, an operating portion, and a controlling portion by which these portions are controlled (not showing in Figures). An electric substrate that an electric component in respective portionsis installed (referred to substrate hereinafter) is accommodated in a shielding case 2 and mounted on the back side (back direction B side) of the image forming apparatus 1 as an electric unit 10.

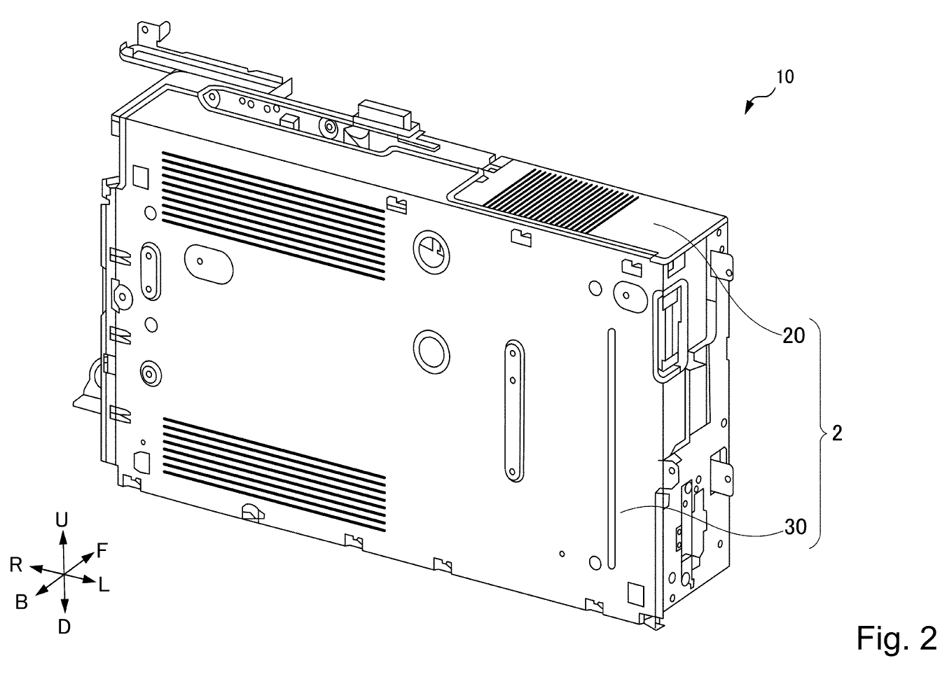

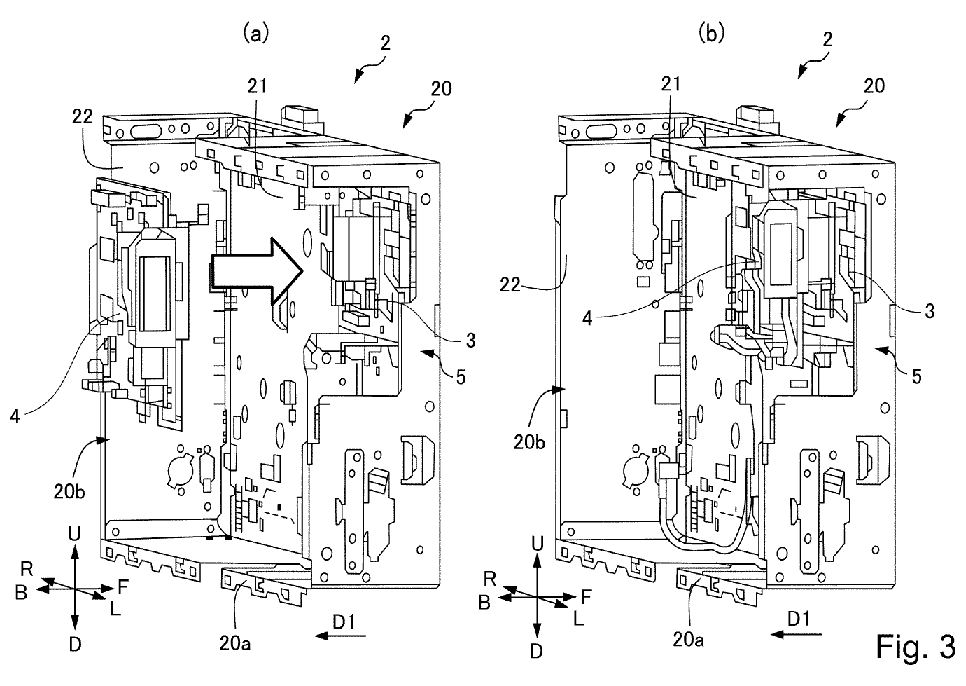

FIG. 2 is a perspective view showing the electric unit 10 of the present embodiment. The electric unit 10 includes the shielding case 2 and an electric component 5 (shown in FIG. 3(a) and (b)) accommodated and supported in the shielding case 2 and shielded electromagnetically. The shielding case 2 includes a case main body 20 formed in a box shape including an opening 20a in the back direction B, a supporting member 30, a case cover 40 provided to cover the opening 20a (shown in FIG. 3(a) and (b)) with respect to the case main body 20. The case main body 20, the supporting member 30, and the case cover 40 are made of metal. Each of the case main body 20, the supporting member 30, and the case cover 40 is formed by a sheet metal with bending method in the present embodiment.

Part (a) of FIG. 3 is a disassembled perspective view showing the shielding case 2 before the electric unit is mounted, and Part (b) of FIG. 3 is a disassembled perspective view showing the shielding case 2 after the electric unit is mounted. The case main body 20 is an example of a first sheet metal. The case main body 20 includes a bottom plate 21, a plurality of side plates 22 (four side plates are applied here). The bottom plate 21 is an example of the first plate portion. A thickness direction of the bottom plate 21 is conveniently called a first direction D1 in the present embodiment. The side plate 22 is an example of a side wall portion. The side plates 22 are extensionally provided from an edge of the bottom plate 21 toward the opening 20a (the case cover 40). In the present embodiment, a first crossing direction which crosses a surface that the bottom plate 21 forms is the same direction as the thickness direction of the bottom plate, in other words, the first direction D1. In the present embodiment, the shielding case 2 is located so as to make the first direction D1 be same as the back direction B. The bottom plate 21 and four of the side plates 22 form an accommodating portion 20b accommodating the electric component 5.

The electric component 5 includes a first substrate 3 and a second substrate 4. The first substrate 3 and the second substrate 4 are electric substrates used in the portions such as the controlling portion or the image forming portion. The first substrate 3 and the second substrate 4 are accommodated in the accommodating portion 20b of the case main body 20 so as to make a mounting surface where the electric component is mounted face in a front/back direction. In other words, an imaginary line that is perpendicular to each of the mounting surface of the first substrate 3 and the second substrate 4 is the same line as the first direction D1. The first substrate 3 and the second substrate 4 are located as they are overlapping at least a part of them when they are seen in a direction along with the first direction D1. In the present embodiment, the first substrate 3 is located in the upstream i.e., in the side of the bottom plate, than the second substrate 4 in the first direction D1. In other words, they are lining in the order of the bottom plate 21, the first substrate 3, and the second substrate 4 in the first direction D1.

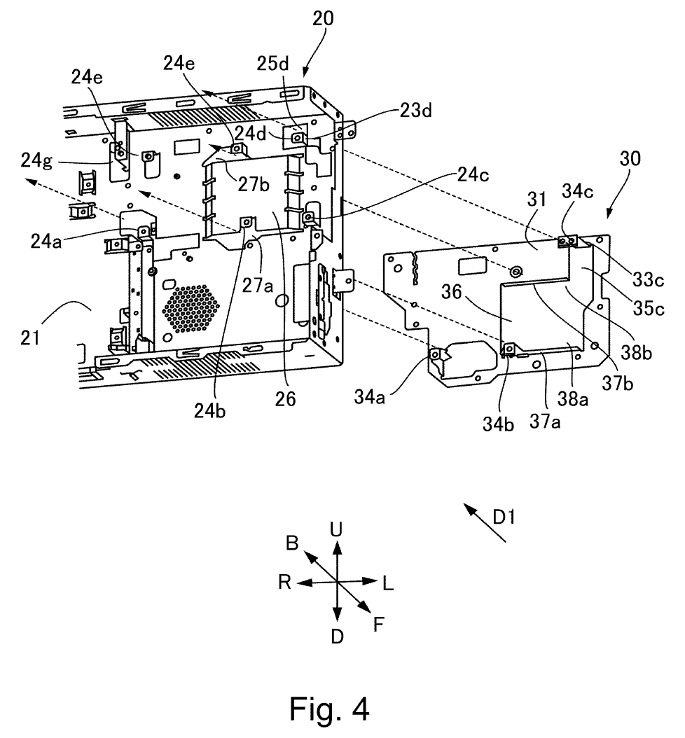

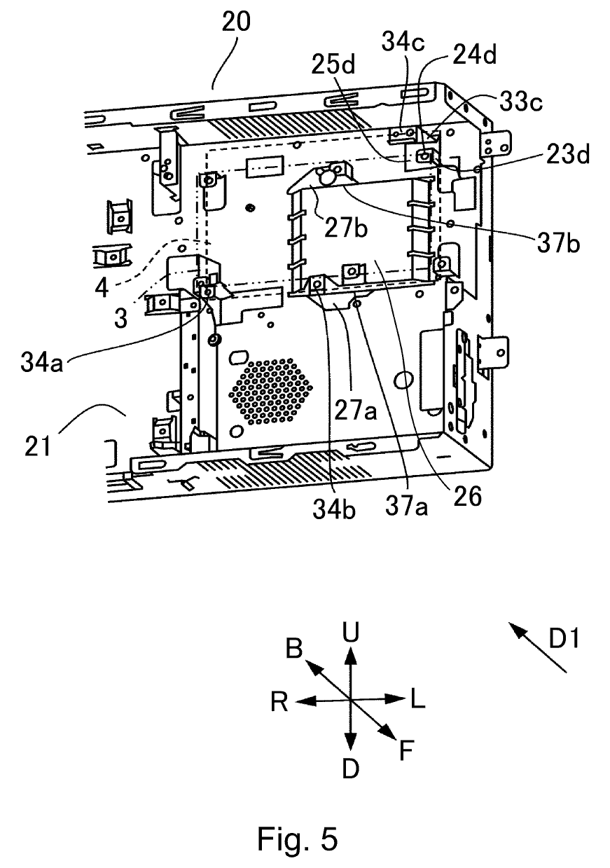

FIG. 4 is a disassembled perspective view showing the case main body 20 and the supporting member 30 of the shielding case seen from the back side in the present embodiment and FIG. 5 is a perspective view of the shielding case seen from the back side in the present embodiment. The supporting member 30 is installed on the bottom plate 21 of the case main body 20 from the front direction F side toward the first direction D1. The supporting member 30 is an example of a second sheet metal. The supporting member 30 includes a plate portion 31. The plate portion 31 is an example of a second plate portion and is mounted on the bottom plate 21 by caulking. FIG. 4 shows each shape of the case main body 20 and the supporting member 30 and a way of combining them before they are fastened. FIG. 5 shows a combined form of the case main body 20 and the supporting member 30 after they are fastened.

On the bottom plate 21 of the case main body 20 a plurality of first supporting portions 24a through 24g supporting the first substrate 3 are formed. For example, the first supporting portion 24d is formed on the leading edge of a first extending portion 23d formed by cutting and raising out of the bottom plate 21 of the case main body 20. More properly, a part of the leading edge of the first extending portion 23d becomes the first supporting portion 24d by that a structure (such as a screw hole) to support the first substrate 3 is formed. Also, a first opening is formed on the bottom plate 21 of the case main body 20 because of cutting and raising out to make the first extending portion and the first supporting portion. For example, a first opening 25d is formed by cutting and raising the first extending portion 23d and the first supporting portion 24d. In other words, the bottom plate 21, the first extending portion 23d, and the first supporting portion 24d are integrally formed with one sheet of a sheet metal by bending processing. Each first extending portion is extended from the edge of the first opening toward the first crossing direction (the same direction as the first direction D1 in the present embodiment) which is crossing to a surface where the bottom plate 21 forms because each of them is formed by cut and raise. Note that, the descriptions of the first extending portion 23d and the supporting portion 24d are the same as the first extending portions 23a through 23g and the first supporting portions 24a through 24g.

The other hands, a plurality of second supporting portions 34a through 34c supporting the second substrate 4 are formed on the plate portion 31 of the supporting member 30. For example, the second supporting portion 34c is formed on the leading edge of the second extending portion 33c and the first supporting portion 24d by cutting and raising out of the plate portion 31 of the supporting member 30. As same as the first extending portion 23d of the case main body 20, a part of the leading edge of the second extending portion 33c becomes the second supporting portion 34c by that a structure (such as a screw hole) to support the second substrate 4 is formed. Also, a second opening is formed on the plate portion 31 because of cutting and raising out to make the second extending portion and the second supporting portion. For example, a second opening 35c is formed by cutting and raising the second extending portion 33c and the second supporting portion 34c. In other words, the plate portion 31, the second extending portion 33c, and the second supporting portion 34c are integrally formed with one sheet of a sheet metal by bending processing. Each second extending portion is extended toward the first direction D1 from the edge of the second opening because being formed by cutting and raising. Note that, the descriptions of the second extending portion 33c and the second supporting portion 34c are the same as the second extending portions 33a and 33b and the second supporting portions 34a and 34b.

The first substrate 3 is supported by the first supporting portions 24a through 24g of the case main body 20 and the second substrate 4 is supported by the second supporting portions 34a through 34c of the supporting member 30 in the present embodiment. As FIG. 3 showing, the second substrate 4 is located in the downstream of the first substrate 3 in the first direction D1. Thus, a distance from the bottom plate 21 to the second supporting portions 34a through 34g is predetermined to be longer than a distance from the bottom plate 21 to the first supporting portions 24a through 24g. Therefore, the second openings which are formed to cut and raise the second supporting portions and the second extending portions tend to be larger than the first openings which are formed to cut and raise the first supporting portions and the first extending portions.

Also, as FIG. 4 and FIG. 5 showing, in order to keep the bottom plate 21 of the shielding case 2 from interfering with other units of the image forming apparatus 1, a drawing portion 26 is formed in the bottom plate 21. The drawing portion 26 is a formed portion that is subjected toward a side of the accommodated portion 20b in the bottom plate 21 by drawing method. Here, when more height of a part with drawing method is needed, it is difficult to process the drawing method in the state that the perimeter of the drawing portion 26 is all connected to the bottom plate 21 in terms of forming process. Thus, forming slit portions 27a and 27b on two segments that face each other in the drawing portion 26 makes it possible to make the part processed with drawing method taller in the present embodiment. In other words, the case main body 20 includes: the slit portions 27a and 27b which are holes with slit shape penetrating the bottom plate 21, and the drawing portion 26 which is connected to the edges of the slit portions 27a and 27b, also including a drawing shape subjecting from the bottom plate 21 in the first direction D1.

Further, in the plate portion 31 of the supporting member 30, a penetrating portion 36 is formed in a position where is fitted for the drawing portion 26 in the bottom plate 21 of the case main body 20. Therefore, it is possible to keep the plate portion 31 from interfering with the other units of the image forming apparatus 1. Also, in the plate portion 31, wall portions 37a and 37b formed by bending in the first direction D1 are provided in positions where are corresponding to the hole positions of the slit portions 27a and 27b of the drawing portion 26 in the bottom plate 21 of the case main body 20. Third openings 38a and 38b are formed in the plate portion 31 by cutting and raising the wall portions 37a and 37b out of the plate portion 31. In other words, the wall portions 37a and 37b are: one of the examples of a third extending portion extending from edges of the third openings 38a and 38b of the plate portion 31 in the first direction D1; and penetrating the slit portions 27a and 27b in the first direction D1. Further, the wall portions 37a and 37b cover at least a part of each slit portion 27a and 27b in the crossing direction of the first direction D1 which is up and down direction in the present direction.

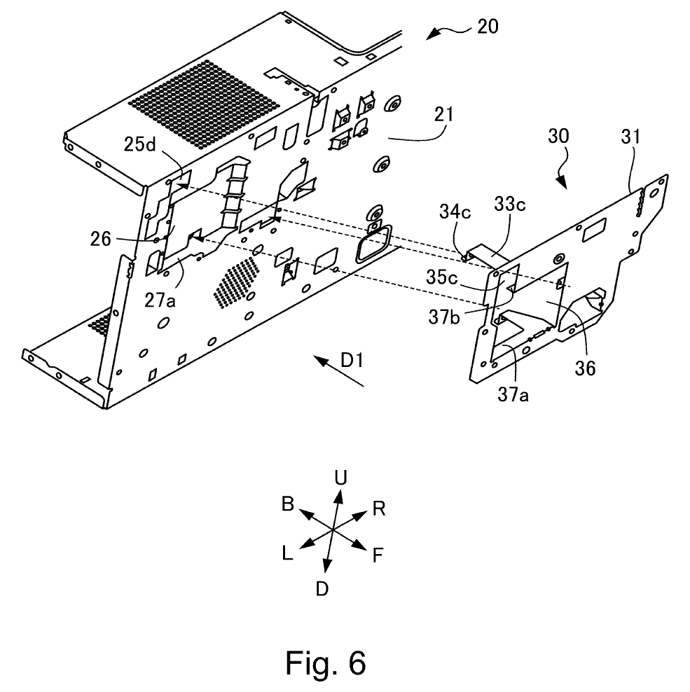

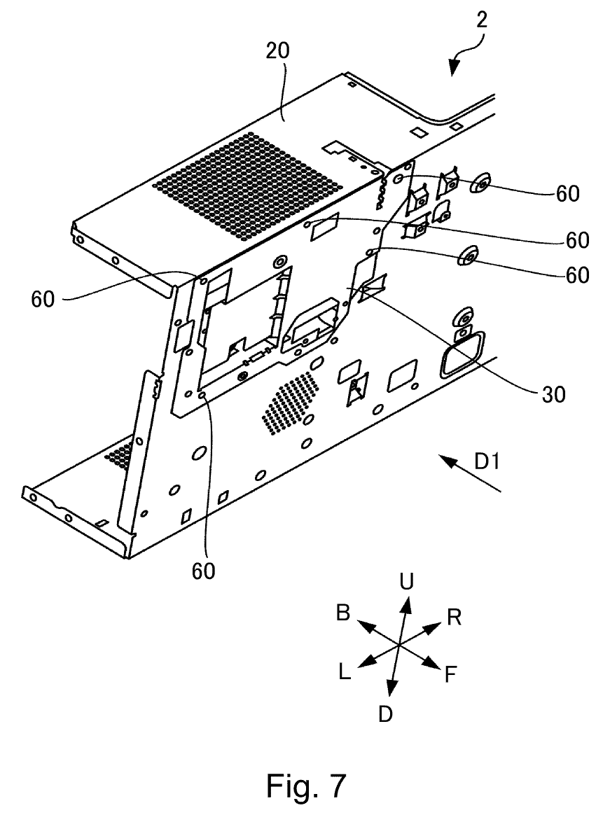

A structure of the shielding case 2 in the present embodiment will be described with FIG. 4 through FIG. 7. FIG. 6 is a perspective view showing the view of the shielding case in FIG. 4 seen from an opposite side (the front side of the apparatus), and FIG. 7 is a perspective view of the view of the shielding case in FIG. 5 seen from an opposite side (the front side of the apparatus). First, a surface where the first substrate 3 mounted, a surface where the bottom plate 21 forms, and a surface where the plate portion 31 forms are parallel each other in the present embodiment. In other words, a perpendicular direction to the surface where the first substrate 3 is mounted, a thickness direction of the bottom plate 21, and a thickness direction of the plate portion 31 are in the same direction. The bottom plate 21 of the case main body 20 and the plate portion 31 of the supporting member 30 are disposed in the same side with reference to the surface where first substrate 3 is mounted as a basis. In other words, they are lining in order of following, the plate portion 31 of the supporting member 30, the bottom plate 21 of the case main body 20, and the first substrate 3 in the perpendicular direction the surface where the first substrate 3 is mounted i.e., the first direction D1.

The bottom plate 21 of the case main body 20 includes the first openings formed by cutting and raising a plurality of the first supporting portions 24a through 24g. The plate portion 31 of the supporting member 30 includes the second openings formed by cutting and raising a plurality of the second supporting portions 34a through 34c. When the case main body 20 and the supporting member 30 are combined, at least a part of the any one of the first openings of the bottom plate 21 is covered by the plate portion 31 of the supporting member 30. Further, at least a part of the anyone of the second openings of the plate portion 31 is covered by the bottom plate 21 of the case main body 20 in the present embodiment. Here, ‘the plate portion 31 covers the first openings’ means that the plate portion 31 covers the first openings when they are viewed in the thickness direction of the bottom plate 21 (i.e., the first direction D1). This is the same relation between the bottom plate 21 and the second openings as well. As described above, the direction for cutting and raising out the first supporting portions 24a through 24g and the second supporting portions 34a through 34c is configured to dispose those openings in the relative positions to cover at least a part of each hole when the case main body 20 and the supporting member 30 are combined in the present embodiment.

As an example, the relation between the second extending portion 33c and the first opening 25d will be described in detail. In this case, the edge of the second opening where the second extending portion 33c is formed covers the first opening 25d. therefore, a part of the first opening 25d is covered by the supporting member 30. In other words, the supporting member 30 is installed to the case main body 20 so as to make: the second extending portion 33c penetrate the first opening 25d in the first direction D1; and the plate portion 31 cover a part of the first opening 25d.

After the supporting member 30 is combined with the case main body 20, they are fastened by calking at a calking position 60. The supporting member 30 is one component and is fastened by caulking several points at once with a pressing machine, so that the assembling time can be suppressed. Note that, the assembling time becomes shorter by caulking process applied in the present embodiment, but it is not limited to. For example, a connecting method such as welding may be used instead of or combined with caulking.

As described above, according to the shielding case 2 in the present embodiment, it is structured by combining the case main body 20 and the supporting member 30. Therefore, for example, at least a part of the opening formed in the case main body 20 can be covered by the supporting member 30 as a supporting portion is forming. Thus, performance of electrical shielding of the shielding case 2 can be improved. Especially, when a plurality of substrates are overlapped and accommodated in the shielding case 2, an area of the opening tends to be larger as a length of the supporting portion becomes longer. Therefore, a problem that the shielding performance tends to be lower is notable. In this case, it is possible to be more effective that the structure which the opening is covered of the present embodiment. Note that, a structure that the bottom plate 21 of the case main body 20 covers the opening on the plate portion 31 of the supporting member 30 is applied in the present embodiment. However, even if the opening on the plate portion 31 of the supporting member 30 is not covered at all, the effect of the shielding performance is still obtained by the plate portion 31 of the supporting member 30 covering the opening in the bottom plate 21.

Further, according to the shielding case 2 in the present embodiment, the slit portions 27a and 27b formed as the drawing portion 26 is forming in the bottom plate 21 of the case main body 20 are covered by wall portions 37a and 37b provided in the supporting member 30. Therefore, performance of electrical shielding of the shielding case 2 can be improved.

Note that, though the supporting member 30 is mounted on the case main body as the plate portion 31 covers a part of the first opening 25d in the embodiment described above, it is not limited to. For example, the supporting member 30 may be mounted on the case main body 20 as the first opening 25d is fully covered by the plate portion 31. In this case, performance of shielding can be improved remarkably.

Further, though the case main body 20 includes the drawing portion 26 in the embodiment described above, it is not limited to but the drawing portion 26 may not be included. Furthermore, though the first substrate 3 and the second substrate 4 are disposed as overlapping in the embodiment described above, it is not limited to but may be disposed without overlapping. Also, a number of the substrate is not limited to two, but may be one or more than three. In the embodiment described above, the first extending portion of the case main body 20 supports the first substrate 3 and the second extending portion of the supporting member 30 supports the second substrate 4. It is not limited to this, but about a substrate or each of the substrate, any options of structures may be applied as follows: (1) a structure that the substrate is supported by the first extending portion of the case main body 20 only, (2) a structure that substrate is supported by the second extending portion of the supporting member 30 only, or (3) a structure that the substrate is supported by the first extending portion of the case main body 20 and the second extending portion of the supporting member 30.

Also, though a case that the shielding case 2 is an accommodation for an electric substrate of an image forming apparatus in the embodiment described above, it is not limited to. For example, it may be widely applied as the shielding case 2 that accommodates a general substrate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-087382 filed on May 29, 2024, which is hereby incorporated by reference herein in its entirety.

What is claimed is:

1. An image forming apparatus provided with an electric unit, the electric unit comprising:
an electric substrate including a mounting surface on which an electric component is mounted;
a first sheet metal including a first plate portion; and
a second sheet metal including a second plate portion disposed on the same side as the first plate portion with respect to the mounting surface of the electric substrate,
wherein a first opening is formed in the first plate portion, the first opening penetrating the first plate portion in a thickness direction of the first plate portion, and
wherein, when viewed in the thickness direction of the first plate portion, the second plate portion covers at least a part of the first opening.

2. The image forming apparatus according to claim 1, wherein the first sheet metal
includes a first extending portion extending from an edge of the first opening in a first crossing direction crossing a surface formed by the first plate portion.

3. The image forming apparatus according to claim 2,
wherein the electric substrate includes at least a first electric substrate, and wherein the first extending portion supports the first electric substrate.

4. The image forming apparatus according to claim 2, wherein the first plate portion and the first extending portion is integrally formed by one sheet metal subjected to a bending method.

5. The image forming apparatus according to claim 1, wherein the second sheet metal incudes a second extending portion extending from, of the second plate portion, a part covering the first opening in a second crossing direction crossing a surface formed by the second plate portion, and
wherein the second extending portion is inserted into the first opening.

6. The image forming apparatus according to claim 5, wherein the second plate portion and the second extending portion is integrally formed by one sheet metal subjected to a bending method.

7. The image forming apparatus according to claim 1, wherein the electric substrate includes at least a first electric substrate and a second electric substrate,
wherein the first sheet metal includes a first extending portion extending from an edge of the first opening in a first crossing direction crossing a surface formed by the first plate portion,
wherein the second sheet metal includes a second extending portion extending from, of the second plate portion, a part covering the first opening in a second crossing direction crossing a surface formed by the second plate portion,
wherein the first extending portion supports the first electric substrate, and
wherein the second extending portion is inserted into the first opening and supports the second electric substrate.

8. The image forming apparatus according to claim 7, wherein, when viewed in the thickness direction of the first plate portion, the first electric substrate and the second electric substrate are at least partially overlapped with each other.

9. The image forming apparatus according to claim 7, wherein a slit portion penetrating the first plate portion in the thickness direction is formed in the first plate portion, and
wherein the first plate portion is adjacent to an edge of the slit portion and includes a drawn portion projecting from the first plate portion in the thickness direction.

10. The image forming apparatus according to claim 9, wherein the second sheet metal includes a third extending portion extending from the second plate portion in the thickness direction and inserted into the slit portion.

11. The image forming apparatus according to claim 7, wherein the first sheet metal includes a side wall portion extending from an edge of the first plate portion toward the same direction as the first extending portion, and
wherein the first plate portion and the side wall portion form a accommodating portion for accommodating the electric substrate.

12. An electric unit for an image forming apparatus, the electric unit comprising:
an electric substrate including a mounting surface on which an electric component is mounted;
a first sheet metal including a first plate portion; and
a second sheet metal including a second plate portion disposed on the same side as the first plate portion with respect to the mounting surface of the electric substrate,
wherein a first opening is formed in the first plate portion, the first opening penetrating the first plate portion in a thickness direction of the first plate portion, and
wherein, when viewed in the thickness direction of the first plate portion, the second plate portion covers at least a part of the first opening.
